(19) United States
(12) Patent Application Publication
(10) Pub. No.: US 2019/0321757 A1
(43) Pub. Date: Oct. 24, 2019

(54) Vacuum Filtration System for Removing Airborne Particulate Pollutants

(71) Applicant: Jibiana Zoe Jakpor, Riverside, CA (US)

(72) Inventor: Jibiana Zoe Jakpor, Riverside, CA (US)

(21) Appl. No.: 16/388,813

(22) Filed: Apr. 18, 2019

Related U.S. Application Data
(63) Continuation-in-part of application No. 29/685,707, filed on Mar. 29, 2019.
(60) Provisional application No. 62/659,243, filed on Apr. 18, 2018.

(51) Int. Cl. B01D 29/01; B01D 29/05; B01D 29/11

(52) U.S. Cl. CPC B01D 29/018; B01D 29/0072; B01D 29/115; B01D 29/05

(57) ABSTRACT

A vacuum filter apparatus is used to induce the influx of polluted air through a replaceable motor driven filter to remove airborne particulate pollutants. The apparatus comprises a frame with an inlet and outlet. The filter is covering the inlet while a vacuum generator is mounted on a hinged lid that covers the outlet. The filter is stretched over a drive roller and wrapped around a passive roller. The driver roller is connected to a motor through a gear box. The vacuum generator includes at least one blower that induces negative pressure inside the frame. A controller is used to control the normal operation of apparatus and alarms a user with the need of filter replacement. A lift assembly provides attachment of the apparatus to any extraneous carrier, thus, achieving substantial cleaning of polluted air right at fire/demolition sources when deployed in air by drones, lifts, etc.

The current application claims a priority to the U.S. Provisional Patent application Ser. No. 62/659,243 filed on Apr. 18, 2018.

### FIELD OF THE INVENTION

The present invention relates generally to vacuum air filtering systems. More specifically, the present invention relates to a vacuum filtering system that creates a negative pressure of the air flow stream, inducing the influx of polluted air through a replaceable reel driven filter to remove airborne particulate pollutants. The present invention can provide substantial cleaning of polluted air right at pollutant sources when deployed in air by drones, cranes, lifts, telescoping masts, etc., wherein the pollutant sources are normally building fires, house fires, wildland fires, building demolitions, etc.

### BACKGROUND OF THE INVENTION

In recent years, the impact of particulate saturated environments such as those induced by wildfires or house fires produces a substantial measure of air pollution with some estimates ranging an impact substantial enough to rival the conventional pollution generated by a sizable society's vehicular emissions. It is estimated that the recent Northern California wildfires have produced as much particulate air pollution in two days as California's cars make in a year. Fires, building demolitions, and the like, are significant sources of particulate air pollution, which is a public health threat. About 9,200 Californians die each year from particulate air pollution—twice the number of people who die from car accidents. These substantial air pollution events can seldom be reined in through conventional means. Although there has been much success at reducing particulate emissions from cars, there are no known attempts to moderate the devastating effect of building fires and demolitions, house fires and wildfires on air quality from the very sources. Even though not all of the smoke from the fires and/or building demolitions may be captured completely, even a partial decrease in the amount of particulate air pollution will save lives.

It is therefore the objective of the present invention to provide a means of actively combatting airborne particulate saturation through a filtering system that is continually refreshed through a reel and motor mechanism within a frame and interior thereof.

Additionally, a negative air pressure may be generated within the frame through a plurality of fan/blower apertures and fan/blower motors thereof that continually generate negative pressure to draw airborne particulate and pollution into the bottom aperture. The filter of the filtering system is rendered parallel and near flush with the bottom surface of the frame, exposed to the bottom aperture to capture particulate and pollution that is drawn into the apparatus. Further, the apparatus of the present invention may be affixed to an extraneous vehicle or structure to offer active measures taken toward particulate saturation and pollution through an extraneous fastening means that may affix to drones, cranes, lifts, trucks, telescoping masts, actuated but anchored bodies and structures, and so on. In a pre-planned control burn, an extraneous fastening means is used to suspend the filter apparatus over the area of the controlled burn in a forest. For uncontrolled and large-scale fire events such as wildfires, multiple squadrons of large autonomous drones flying in formations controlled by artificial intelligence or by operators on the ground can be used to suspend multiple filtering systems of present invention into the areas with the most smoke. Thus, the present invention provides effective, active, and efficient filtration to combat air particulate saturation and pollution such as those produced by wild fires, building fires and demolitions, house fires, and other particulate saturation hazards right at the sources.

### SUMMARY OF THE INVENTION

A vacuum filtering system is used to create a negative pressure of the air flow stream, inducing the influx of polluted air through a replaceable filter continually refreshed through a roller and motor mechanism to remove airborne particulate pollutants. The apparatus comprises a frame with an inlet and outlet. The filter is covering the inlet while a vacuum generator is mounted on a hinged lid that covers the outlet. The filter is stretched over a drive roller, through an optional plurality of tightening rollers, and wrapped around a passive roller, all being mounted on the interior of the apparatus. The driver roller is connected to a motor through a gear box.

The vacuum generator includes at least one blower that induces negative pressure inducing polluted air passing through the filter, thus, getting cleaned and exiting the outlet of the apparatus. The blower of the vacuum generator and the motor of the filter assembly are controlled by a controller through a relay. The controller receives input data and/or signals from a plurality of sensors, controls the normal operation of apparatus, and sends status and/or alarm signals to a plurality of status indicators to the user including the need of filter replacement.

Further, the apparatus comprises a lift assembly which provides efficient and effective attachment of the present invention to any extraneous carrier such as a lift, a crane, a telescoping mast, a drone, and/or any combination thereof, actuated but anchored bodies and structures, and so on. In a pre-planned control burn, an extraneous fastening means is used to suspend the filter apparatus over the area of the controlled burn in a forest. For uncontrolled and large-scale fire events such as wildfires, multiple squadrons of large autonomous drones flying in formations controlled by artificial intelligence or by operators on the ground can be used to suspend multiple filtering systems of present invention into the areas with the most smoke. Thus, the present invention provides effective, active, and efficient filtration to combat air particulate saturation and pollution right at the source. Thus, the vacuum filtering system can provide substantial cleaning of polluted air right at pollutant sources when deployed in air by drones, lifts, etc., wherein the pollutant sources can normally be building fires, house fires, wildland fires, building demolitions, etc.

### BRIEF DESCRIPTION OF THE DRAWINGS

FIG. 1 is a perspective view of the apparatus of the present invention.

FIG. 2 is a rear sectional view of the apparatus thereof.

FIG. 3 is a top view of the apparatus thereof.

FIG. 4 is a perspective view of the apparatus wherein the hinged lid and the side door are rendered open.

FIG. 5 is a front sectional view of the apparatus thereof, where the plurality of rollers is observed on the interior.

FIG. 6 is an electrical diagram of the apparatus thereof.

### DETAIL DESCRIPTIONS OF THE INVENTION

All illustrations of the drawings are for the purpose of describing selected versions of the present invention and are not intended to limit the scope of the present invention.

The present invention is a vacuum filtration system for removing air particulate pollutants, especially generated by wildfires, building fires, building demolitions, house fires, etc. The vacuum filtration apparatus of the present invention is used to actively combat airborne particulate saturation through a filtering system that is continually refreshed through a reel and motor mechanism within a frame and interior thereof. Additionally, a negative air pressure may be generated within the frame through a plurality of fan/blower apertures and fan/blower motors thereof that continually generate negative pressure to draw airborne particulate and pollution into the bottom aperture. The filter of the filtering system is rendered parallel and near flush with the bottom surface of the frame, exposed to the bottom aperture to capture particulate and pollution that is drawn into the apparatus. Further, the apparatus of the present invention may be suspended above the sources of airborne particulate pollutants using an extraneous vehicle or structure to provide the effective air filtration. The extraneous vehicle of structure may include, but is not limited to, drone, crane, lift, truck, telescoping mast, actuated but anchored body and structure, any combination thereof, and so on. Further for a pre-planned control burn, an extraneous fastening means is used to suspend the filter apparatus over the area of the controlled burn in a forest. For uncontrolled and large-scale fire events such as wildfires, multiple squadrons of large autonomous drones flying in formations controlled by artificial intelligence or by operators on the ground can be used to suspend multiple filtering systems of present invention into the areas with the most smoke. Thus, the present invention provides effective, active, and efficient filtration to combat air particulate saturation and pollution such as those produced by wild fires, building fires and demolitions, house fires, and other particulate saturation hazards right at the sources.

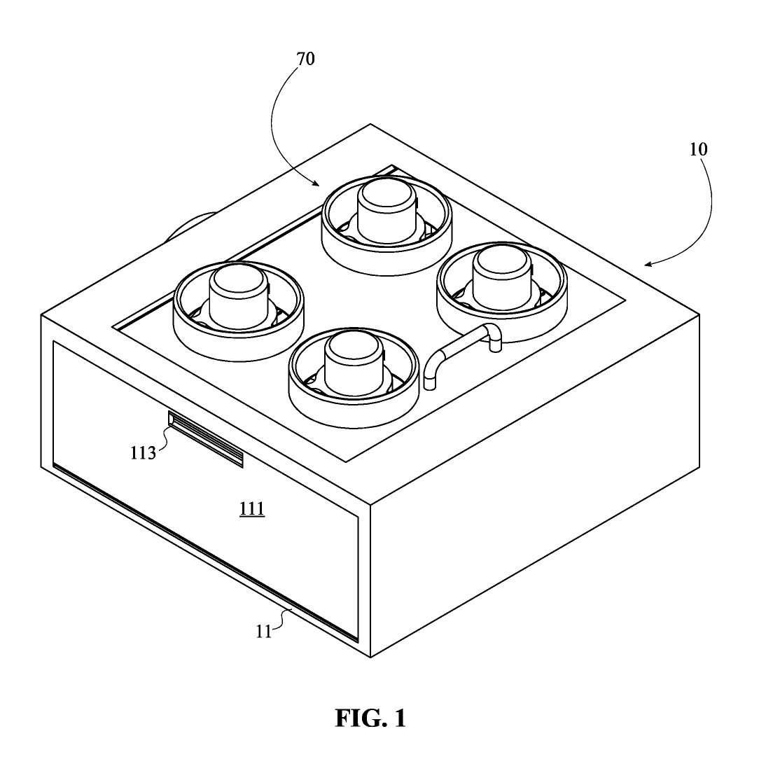

As can be seen FIG. 1 to FIG. 6, the present invention generally includes a vacuum filtration apparatus that comprises a frame 10, a filter assembly 50, a vacuum generator 70, and a control panel 80. The frame comprises a front 11, a back 12, a first side 13, a second side 14, an inlet 15, and an outlet 16. More specifically, the inlet 15 is terminally positioned on one end of the front 11 and the back 12, while the outlet 16 is terminally positioned on the front 11 and the back 12, opposite the inlet 15. The filter assembly 50 is interiorly mounted on the frame 10 and provides filtration to the air flow induced by the vacuum generator 70, which is mounted on the outlet 16 of the frame 10. The air flow induced is from the inlet 15, through the interior of the frame 10, to the outlet 16 of the frame 10. Additionally, the control panel 80 is mounted to the back 12 of the frame 10 and provides controls, status indications of the apparatus.

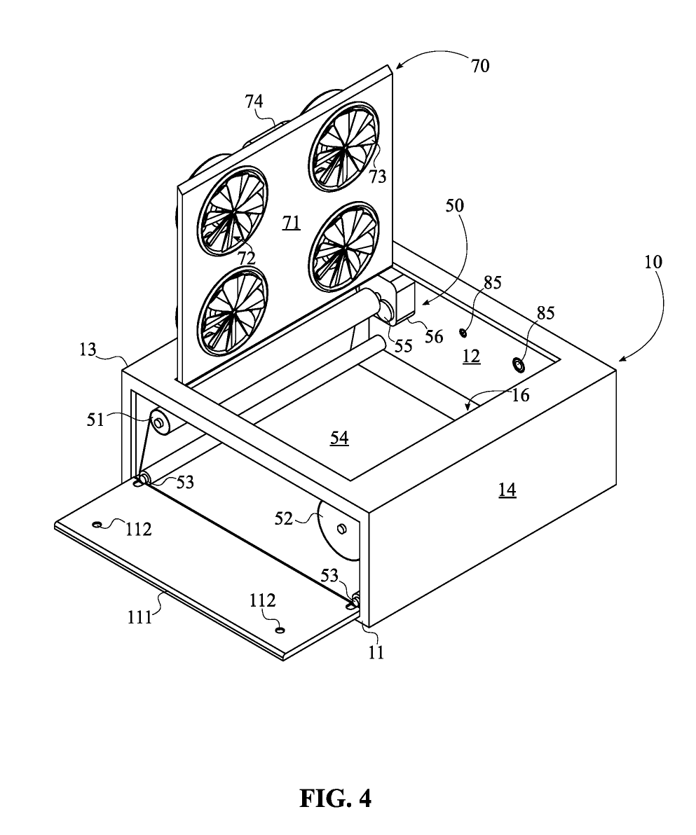

The frame 10 can be, but is not limited to, rectilinear or cubic geometry that houses the majority of components therein or interstitially through the frame's shell. The frame 10 is preferably capable of being rendered to an extraneous actuator or similar that the apparatus could then be employed thereto a device or machine including, but not limited to, a vehicle, crane, lift, or drone. Additionally, the frame 10 may be made of any number of materials including, but not limited to: metallic, ceramic, plastics, and so on. As seen in FIG. 4, the front 11 comprises a side door 111, a plurality of holes 112, and a side door handle 113. The side door 111 is longitudinally hinged, adjacent the inlet 15. The plurality of holes 112 is distributed on the interior surface of the side door 111. The side door handle 113 is positioned on the exterior of the side door 111, adjacent the outlet 16. The side door 111 can be closed and locked during the normal operation of the apparatus, providing rigid support to the components mounted to the interior of the frame 10. Additionally, the side door 111 may be opened to allow a user to access the components mounted on the interior of the frame 10. The side door handle 113 provides the user a convenient and efficient way to open and close the side door 111. Additionally, the handle 113 may be, but is not limited to, tubular or recessed on the side door 111, and can be made of any number of materials including, but not limited to, rubber, metals, plastics, and so on.

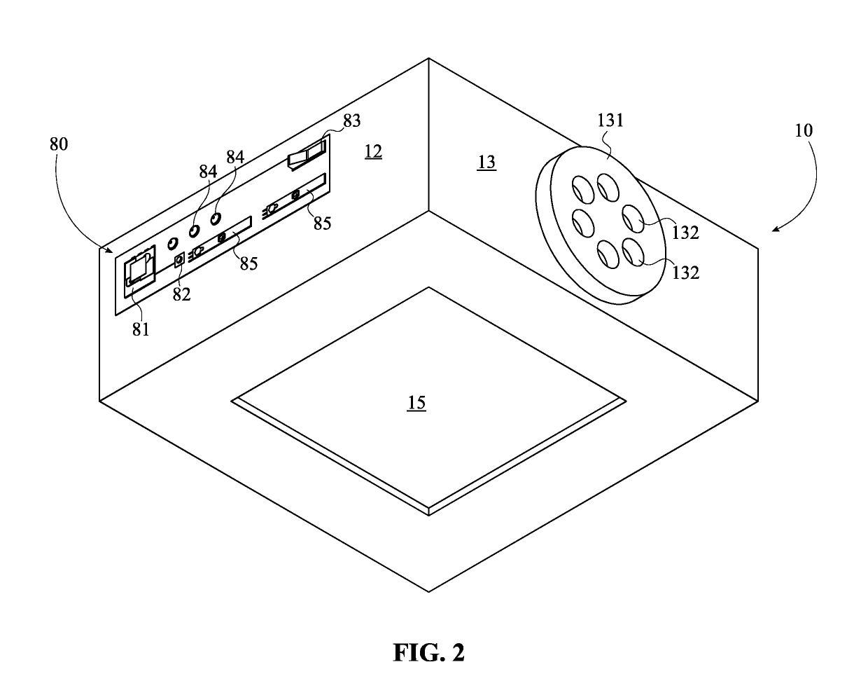

As seen in FIG. 2, the first side 13 of the frame 10 comprises a lift assembly 131 and a plurality of holes 132. The lift assembly 131 is exteriorly mounted to the first side 113 of the frame 10. The plurality of holes 132 is distributed on the lift assembly 131 and provides an effective mechanism for the user to attach the present invention to an extraneous vehicle or structure including, but not limited to, drone, crane, lift, truck, telescoping mast, actuated but anchored body and structure, any combination thereof, and so on. Additionally, the lift assembly 131 can be of a shape including, but not limited to, circular, oval, square, rectangular, triangular, etc.

As can be seen in FIG. 2, the inlet 15 of the frame 10 comprises a shape including, but not limited to, square, rectangular, oval, circular, and any other suitable shape. The inlet 15 provides an entry port of polluted air, which flows through the filter assembly 50 inside the frame 10, exiting the outlet 16 through the vacuum generator 70.

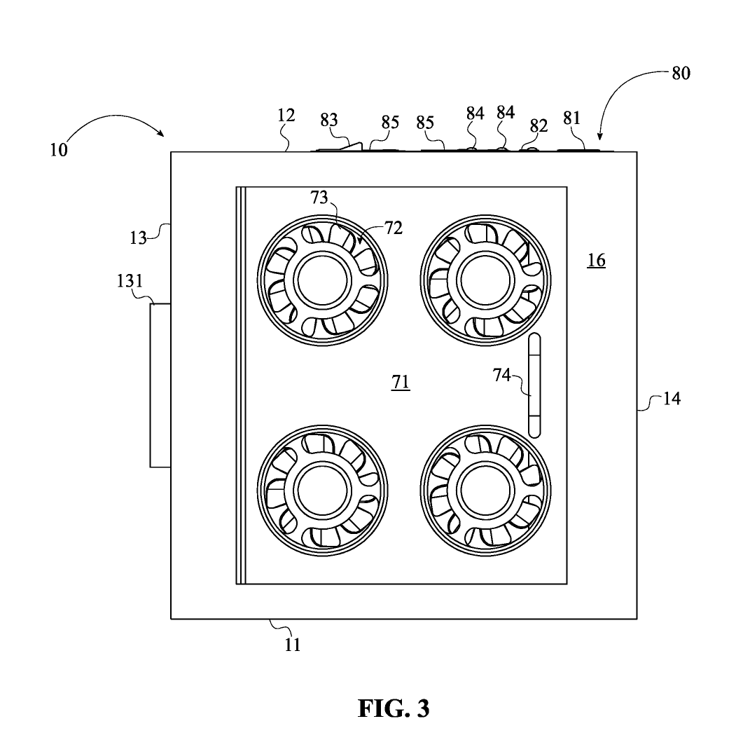

As can be seen in FIG. 1, and FIG. 3 to FIG. 5, the vacuum generator 70 comprises a hinged lid 71, at least one hole 72, at least one blower 73, and a handle 74. The hinged lid 71 provides housing of the at least one blower 73, the handle 74, and connection of the vacuum generator 70 to the outlet 16 of the frame 10. The hinged lid 71 can be of a shape including, but not limited to, square, rectangular, curved, oval, circular, semi-circular, rectangular, etc. Additionally, the hinged lid 71 is terminally connected to the outlet 16 of the frame 10, adjacent the first side 13. The at least one blower 73 is mounted within the at least one hole 72 of the hinged lid 71 and is configured such that the outside air can be induced through the inlet 11 of the frame 10, the filter assembly 50, exiting the outlet 16 of the frame 10 through the at least blower 73 of the vacuum generator 70 when running and creating the vacuum inside the frame 10. Further, the hinged lid 71 can be locked onto the frame 10 to fully covering the outlet 16 of the frame 10 during normal filtration operation of the apparatus. The handle 74 is mounted to the hinged lid 71 of the vacuum generator 70, adjacent the second side 14 of the frame 10. When the hinged lid 71 is opened by the user using the handle 14, the filter assembly 50 can be accessed for the filter replacement, maintenance and repair of any interior component of the apparatus.

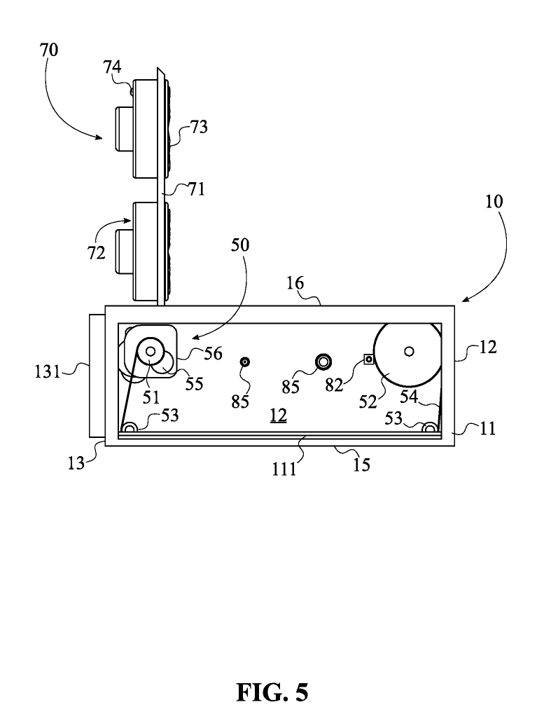

As can be seen in FIG. 4 to FIG. 5, the filter assembly 50 is mounted to the interior of the frame 10. The filter assembly 50 comprises a drive roller 51, a passive roller 52, a plurality of tightening rollers 53, a filter 54, a motor 55, a gear box 56. The gear box 56 is mounted to the interior surface of the back 12 of the frame, adjacent the first side 13. The motor 55 is connected to the drive roller 51 through the gear box 56, and drives the entire filter assembly 50. The drive roller 51 is mounted between the gear box 56 and one of the plurality of holes 112 of the side door 111 of the frame 10 when the side door 111 is closed and locked on the frame 10. However, the drive roller 51 can be held by the connection to the gear box 56, suspended like a cantilever. The passive roller 52 is mounted to the interior surface of the back 12 of the frame 10. The passive roller is positioned opposite the drive roller 51. Additionally, the passive roller 52 is held by the connection to the back 12 and can be suspended when the side door 111 of the frame 10 is opened. During normal filtration operation when the side door 111 is closed and locked, the passive roller 52 is terminally and concentrically connected to one of the plurality of holes 112 of the frame 10. The plurality of tightening rollers 53 is mounted to the back 12 of the frame 10, adjacent the inlet 15 of the frame 10. Additionally, the plurality of tightening rollers 53 is oriented parallel with the drive roller 51 and the passive roller 52,opposite either the drive roller 51 or the passive roller 52. Further, the plurality of tightening rollers 53 is held by the connection to the back 12 and can be suspended when the side door 111 of the frame 10 is opened. Just like the passive roller 52, during normal filtration operation when the side door 111 is closed and locked, each of the plurality of tightening rollers 53 is terminally and concentrically connected to one of the plurality of holes 112 of the frame 10. The filter 54 is concentrically mounted on the drive roller 51, stretched over the plurality of tightening rollers 53, and wrapped around the passive roller 53 to fully cover the inlet 15 of the frame 10. Additionally, the filter 54 is preferably cloth or synthetic in a roll form, but may comprise a wide array of malleable or flexible material. In another embodiment of the present invention, the filter assembly 50 may not comprises any of the plurality of tightening rollers 53.

As can be seen in FIG. 2, the back 12 of the frame 10 comprises a control panel 80. The control panel 80 is exteriorly mounted on the back 12 of the frame 10. The control panel 80 comprises a controller 81, a relay 82, a power switch 83, a plurality of sensors 84, and a plurality of status indicators 85. As seen in FIG. 2 and FIG. 4 to FIG. 5, the controller 81, the power switch 83, and the plurality of status indicators 85 are positioned on the control panel 80. More specifically, the controller 81 provides the central control of the apparatus to function properly. The controller 81 of the present invention is mounted on the control panel 80 and can include, but is not limited to, a microprocessor, a central processing unit (CPU), a programmable logic controller (PLC), a proportional integral derivative (PID) controller, and any other suitable controller. Additionally, the controller 81 can be a wired or wireless controller that is capable of wireless communication through a communication network including, but not limited to, Internet. The power switch 83 provides the control of power supplied to the apparatus through a power source including, but not limited to, internal power source such as a battery, any type of external power source. The plurality of status indicators 85 can display the status of the apparatus and/or specific components or systems. More specifically, the plurality of status indicators 85 can include, but is not limited to, status of power, status of the at least one blower 73 of the vacuum generator 70, status of the filter 54 of the filter assembly 50, the status of the motor 55 of the filter assembly 50, etc. The plurality of status indicators 85 is capable of providing alarms to warm the user for any problems of the apparatus and/or the need of replacing the filter 54 when the filter 54 is used up. Further, the plurality of status indicators 85 can include, but is not limited to, LED (light-emitting diode), machine status indicators such as signaling, beacon, strobe, rotating, mounting, stacking, incandescent, flashing, warning, blinker, emergency, pilot and safety lights. As seen in FIG. 2 and FIG. 4 to FIG. 5, the relay 82 and the plurality of sensors 84 are positioned on the control panel 80 and penetrated through the back 12 and into the interior of the frame 10. The plurality of sensors 84 provides the detection of various components of the apparatus to the controller 81 for the control of the filtration operation. Additionally, the plurality of sensors 84 can include, but is not limited to, a motor speed sensor such as an accelerometer, a blower/fan speed sensor, sensor for the filter 54 of the filter assembly 50. The relay 82 provides connections to the motor 55 of the filter assembly 50 and the at least one blower 73 of the vacuum generator 70.

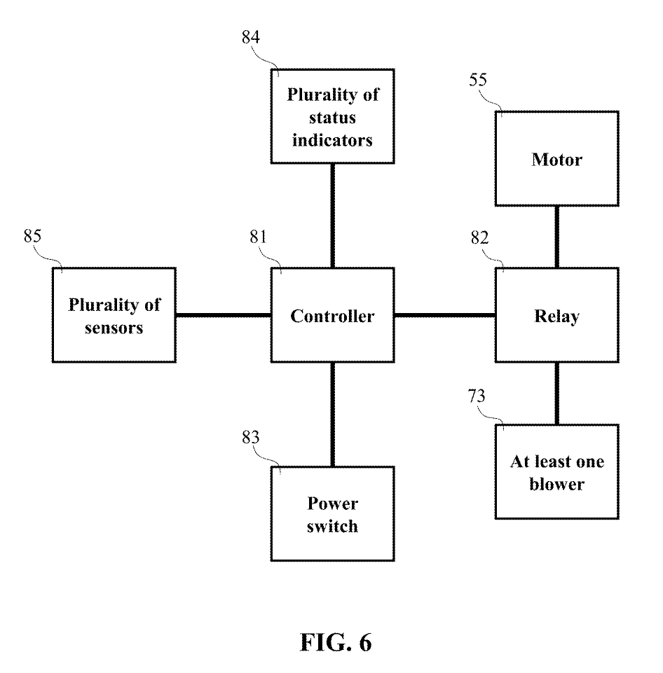

As can be seen in FIG. 6, the controller 81 is the center of the control system for the filtration operation of the present invention. More specifically, the controller 81 is electrically connected to the relay 82, the power switch 83, the plurality of status indicators 84, and the plurality of sensors 85. The relay 82 is electrically connected to the motor 55 of the filter assembly 50 and the at least one blower 73 of the vacuum generator 70. The controller takes input data and signals from the plurality of sensors 85, sends control signals to motor 55 of the filter assembly 50 and the at least one blower 73 through the relay 82, and energizes the plurality of status indicators 84 under specific system situations for displaying various system statuses and/or alarming the user of any necessary actions needed. Further, the apparatus of the present invention allows the user to access the controller 81 manually and/or wirelessly to change parameters including, but not limited to, the speed of the motor 55 of the filter assembly 50, the at least one blower 73 of the vacuum generator 70, etc. Further, all these electronic components may preferably be provided with a form of heat shielding to mitigate heat damage to the components of the apparatus including, but not limited to, the motor 55 of the filter assembly 50, the blower 73 of the vacuum generator 70, etc. All electronic components of the control panel 80 are heat resistant.

Although the invention has been explained in relation to its preferred embodiment, it is to be understood that many other possible modifications and variations can be made without departing from the spirit and scope of the invention as hereinafter claimed.

What is claimed is:

1. A vacuum filtration system for removing airborne particulate pollutants comprising:
a frame;
a filter assembly;
a vacuum generator;
the frame comprising an inlet, an outlet, a front, a back, a first side, and a second side;
the inlet being terminally positioned on one end of the front and the back;
the outlet being terminally positioned on the front and the back, opposite the inlet;
the filter assembly comprising a motor, a gear box, a drive roller, a passive roller; and a filter;
the gearbox being interiorly mounted on the back of the frame, adjacent to the first side and outlet;
the motor being connected to the drive roller through the gear box;
the drive roller being terminally and interiorly mounted on the front;
the passive roller being terminally and interiorly mounted on the front and back, opposite the drive roller;
the filter being concentrically mounted on the drive roller;
the filter being wrapped around the passive roller, fully covering the inlet of the frame;
the vacuum generator comprising a hinged lid, at least one hole, and at least one blower;
the at least one blower being mounted within the hinged lid; and
the hinged lid being peripherally connected to the outlet of the frame, adjacent the first side.

2. The vacuum filtration system for removing airborne particulate pollutants as claimed in claim 1 comprising:
the hinged lid of the vacuum assembly comprising a handle; and
the handle being positioned on the hinged lid opposite the hinged side adjacent the second side of the frame.

3. The vacuum filtration system for removing airborne particulate pollutants as claimed in claim 1 comprising:
the filter assembly comprising a plurality of tightening rollers;
each of the plurality of tightening rollers being mounted on the front and the back of the frame, adjacent the inlet; and
the filter being wrapped around each of the plurality of tightening rollers.

4. The vacuum filtration system for removing airborne particulate pollutants as claimed in claim 1 comprising:
the front of the frame comprising a hinged door, a handle, and a plurality of holes;
the hinged door being terminally connected to the front, adjacent the inlet;
the handle being positioned on the hinged door adjacent the outlet;
the plurality of holes being interiorly distributed on the hinged door; and
each of the plurality of holes being concentrically and terminally connected to the drive roller, the plurality of tightening rollers, and the passive roller of the filter assembly.

5. The vacuum filtration system for removing airborne particulate pollutants as claimed in claim 1 comprising:
the first side of the frame comprising a lift assembly;
the lift assembly being exteriorly and terminally mounted to the first side;
the lift assembly comprising a plurality of holes; and
the plurality of holes being distributed on the lift assembly.

6. The vacuum filtration system for removing airborne particulate pollutants as claimed in claim 1 comprising:
a control panel;
the control panel being exteriorly mounted on the back of the frame;
the control panel comprising a controller, a relay, and a plurality of sensors;
the relay and the plurality of sensors being positioned on the control panel and penetrating the back into the interior of the frame;
the relay and the plurality of sensors being electrically connected to the controller; and
the relay being electrically connected to the motor of the filter assembly and the at least one blower of the vacuum generator.

7. The vacuum filtration system for removing airborne particulate pollutants as claimed in claim 6, wherein the controller being a wireless controller.

8. The vacuum filtration system for removing airborne particulate pollutants as claimed in claim 6 comprising:
the control panel comprising a power switch; and
the power switch being electrically connected to the controller.

9. The vacuum filtration system for removing airborne particulate pollutants as claimed in claim 6 comprising:
the control panel comprising a plurality of status indicators; and
the plurality of status indicators being electrically connected to the controller.

10. A vacuum filtration system for removing airborne particulate pollutants comprising:
a frame;
a filter assembly;
a vacuum generator;
a control panel;
the frame comprising an inlet, an outlet, a front, a back, a first side, and a second side;
the inlet being terminally positioned on one end of the front and the back;
the outlet being terminally positioned on the front and the back, opposite the inlet;
the filter assembly comprising a motor, a gear box, a drive roller, a passive roller; and a filter;
the gearbox being interiorly mounted on the back of the frame, adjacent to the first side and outlet;
the motor being connected to the drive roller through the gear box;
the drive roller being terminally and interiorly mounted on the front;
the passive roller being terminally and interiorly mounted on the front and back, opposite the drive roller;
the filter being concentrically mounted on the drive roller;
the filter being wrapped around the passive roller, fully covering the inlet of the frame;
the vacuum generator comprising a hinged lid, at least one hole, and at least one blower;
the at least one blower being mounted within the hinged lid;
the hinged lid being peripherally connected to the outlet of the frame, adjacent the first side;
the control panel being exteriorly mounted on the back of the frame;
the control panel comprising a controller, a relay, and a plurality of sensors;
the relay and the plurality of sensors being positioned on the control panel and penetrating the back into the interior of the frame;
the relay and the plurality of sensors being electrically connected to the controller; and
the relay being electrically connected to the motor of the filter assembly and the at least one blower of the vacuum generator.

11. The vacuum filtration system for removing airborne particulate pollutants as claimed in claim 10 comprising:
the hinged lid of the vacuum assembly comprising a handle; and
the handle being positioned on the hinged lid opposite the hinged side adjacent the second side of the frame.

12. The vacuum filtration system for removing airborne particulate pollutants as claimed in claim 10 comprising:
the filter assembly comprising a plurality of tightening rollers;
each of the plurality of tightening rollers being mounted on the front and the back of the frame, adjacent the inlet; and
the filter being wrapped around each of the plurality of tightening rollers.

13. The vacuum filtration system for removing airborne particulate pollutants as claimed in claim 10 comprising:
the front of the frame comprising a hinged door, a handle, and a plurality of holes;
the hinged door being terminally connected to the front, adjacent the inlet;
the handle being positioned on the hinged door adjacent the outlet;
the plurality of holes being interiorly distributed on the hinged door; and
each of the plurality of holes being concentrically and terminally connected to the drive roller, the plurality of tightening rollers, and the passive roller of the filter assembly.

14. The vacuum filtration system for removing airborne particulate pollutants as claimed in claim 10 comprising:
the first side of the frame comprising a lift assembly;
the lift assembly being exteriorly and terminally mounted to the first side;
the lift assembly comprising a plurality of holes; and
the plurality of holes being distributed on the lift assembly.

15. The vacuum filtration system for removing airborne particulate pollutants as claimed in claim 10, wherein the controller being a wireless controller.

16. The vacuum filtration system for removing airborne particulate pollutants as claimed in claim 10 comprising:
the control panel comprising a power switch; and
the power switch being electrically connected to the controller.

17. The vacuum filtration system for removing airborne particulate pollutants as claimed in claim 10 comprising:
the control panel comprising a plurality of status indicators; and
the plurality of status indicators being electrically connected to the controller.
